(19) United States
(12) Patent Application Publication
(10) Pub. No.: US 2006/0045034 A1
(43) Pub. Date: Mar. 2, 2006

(54) Wireless networking apparatus and channel switching method using the same

(75) Inventors: Chang-yeul Kwon, Seongnam-si (KR); Suk-jin Yun, Seoul (KR); Chil-youl Yang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/196,447

(22) Filed: Aug. 4, 2005

(30) Foreign Application Priority Data
Aug. 27, 2004 (KR) 10-2004-0067922

(51) Int. Cl. H04B 7/00

(52) U.S. Cl. 370/310

(57) ABSTRACT

A networking apparatus and channel switching method being used by the same, wherein the networking apparatus includes a beacon frame checking unit which determines whether a beacon frame to be transmitted to a device has been transmitted, a channel searching unit which searches for another channel as a result of the determination, and a first channel switching unit which switches a current channel to another channel as a result of the search.

### CROSS-REFERENCE TO RELATED APPLICATION

This application claims priority from Korean Patent Application No. 10-2004-0067922 filed on Aug. 27, 2004, the disclosure of which is incorporated herein in its entirety by reference.

### BACKGROUND OF THE INVENTION

1. Field of the Invention

Apparatuses and methods consistent with the present invention relate to wireless networking and switching of a communication channel by the same. More particularly, the present invention relates to a wireless network device capable of switching a communication channel in order to prevent interference between wireless networks, and a communication channel switching method being used by the same.

2. Description of the Related Art

In contrast to a general local area network (LAN), a wireless LAN (WLAN) does not require physical wiring. A WLAN refers to a network where data is transmitted and received between stations that are located at a fixed distance apart, and between stations that can freely move.

Generally, a basic configuration of an IEEE 802.11 WLAN is based on a basic service set (BSS). The BSS consists of an independent network, i.e., an independent basic service set (IBSS) and an infrastructure network, i.e., an infrastructure BSS.

In the infrastructure network, a beacon frame is transmitted by an access point (AP). The range of the beacon frame defines a basic service area.

An IBSS network is an IEEE 802.11 network which does not use an AP. In particular, an IBSS network is an ad hoc network that directly communicates with other stations within the BSS.

Access to the transmission medium proposed by the IEEE 802.11 standard is accomplished using a distributed coordination function (DCF) and a point coordination function (PCF).

FIG. 1 illustrates transmission of data between stations according to the PCF. Generally, the PCF is used together with the DCF. A DCF area starts where a PCF area ends, thereby constituting as a whole a single repeated area (a contention-free period (CFP) repeated area).

Here, D1, D2 and the like refer to frames transmitted from a point coordinator, and U1, U2 and the like refer to frames transmitted from stations having received polls. A CFP observing PCF rules begins when the point coordinator first transmits a beacon.

A polling operation for the point coordinator present in an AP to ask each station if it has data to be transmitted is conducted in a round-robin method by each station.

When the point coordinator conducts a poll, the station having received the poll transmits data and an acknowledgement (ACK) to the point coordinator. Then, the point coordinator transmits the data and the ACK to the station, and it then polls.

The station having received the poll transmits an another ACK to the point coordinator, along with any data to be transmitted. In this manner, data is received and transmitted between stations during a CFP.

FIG. 2 illustrates backoff according to the DCF.

A PCF supplies contention-free services whereas the DCF supplies contention-based services. The DCF employs a recursive backoff window mechanism to thereby prevent any collision.

Use of any medium in the DCF is determined based on a DCF interface frame space (DIFS) which is approximately 34 μs.

As illustrated, a contention period (CP) based on the DCF is allocated to any participating station, in which a contention window of a predetermined size is set up next to a DIFS period, and the size of a random slot having the same probability to be selected by a backoff algorithm is within an IBSS.

When frame transmission by Station A using the current channel finishes, Stations B, C and D that have delayed frame transmission participate in a contention to secure a channel after a DIFS. The frame transmission begins when a backoff timer of Station C, which has selected the shortest backoff time in the first contention window, reaches zero.

In the second contention window after the DIFS, Stations B, D and E participate in a contention. Through the same procedure described above, Station D secures the medium and begins frame transmission.

In the third contention window, Stations B and E participate in a contention. Through the same procedure described above, Station E secures medium and begins frame transmission.

In the fourth contention window, only Station B wants to transmit data. Through the same procedure described above, Station B secures medium and begins frame transmission.

Due to the popularization of digital products, there is an increasing demand to develop high-speed WLANs in excess of 100 Mbits/sec. Among candidate technologies to increase the speed of next generation WLANs is multiple input multiple output (MIMO) technology.

When a predetermined channel is used by multiple BSSs or IBSSs, each station has difficulty getting an opportunity to transmit data.

Because of this, the probability of data collision increases, thereby causing packet losses and reducing the effective bandwidth.

Specifically, when two BSSs share a channel as depicted in FIG. 3, the rates (10 and 20) of data transmission of stations included in each BSS and the entire bandwidth decrease.

Therefore, a method is needed to secure the bandwidth required for data transmission and prevent packet losses when a large number of wireless networks using a predetermined channel exist, by sensing the bandwidth drop and packet losses and switching to a better channel.

Korean Unexamined Patent Publication No. 2003-0059122 discloses consolidation of BSS and IBSS structures available for dynamic frequency selection for a WLAN. Immediately after a dynamic frequency selection (DFS) owner station within the IBSS network has received a beacon having a DFS count value of zero, it can select a frequency to recover BSS wireless networking by performing channel measurements to select a new channel. However, Korean Unexamined Patent Publication No. 2003-0059122 does not disclose a method to secure the bandwidth and prevent packet losses when there exists a large number of wireless networks using a predetermined channel.

### SUMMARY OF THE INVENTION

The present invention provides a wireless networking apparatus and a communication channel switching method using the same, to thereby avoid collisions where a predetermined channel is used by a large number of wireless networks.

According to an aspect of the present invention, there is provided a wireless networking apparatus including a beacon frame checking unit which determines whether a beacon frame to be transmitted to a device has been transmitted, a channel searching unit which searches for another channel as a result of the determination, and a first channel switching unit which switches a current channel to another channel as a result of the search.

According to another aspect of the present invention, there is provided a wireless networking apparatus including a channel information receiving unit which receives channel information from a device, a second memory unit which stores the received channel information therein, and a second channel switching unit which switches a current channel to the channel corresponding to the stored channel information.

According to a further aspect of the present invention, there is provided a channel switching method of a wireless networking apparatus, the method including determining whether a beacon frame to be transmitted to a device has been transmitted, searching for another channel as a result of the determination, and switching a current channel to the channel found as a result of the search.

According to yet another aspect of the present invention, there is provided a channel switching method of a wireless networking apparatus, the method including receiving channel information from a device, storing the received channel information, and switching a current channel to the channel specified in the stored channel information.

### BRIEF DESCRIPTION OF THE DRAWINGS

The above and/or other aspects of the present invention will become more apparent by describing in detail exemplary embodiments thereof with reference to the attached drawings in which:

FIG. 1 illustrates data transmission among stations according to a general PCF;

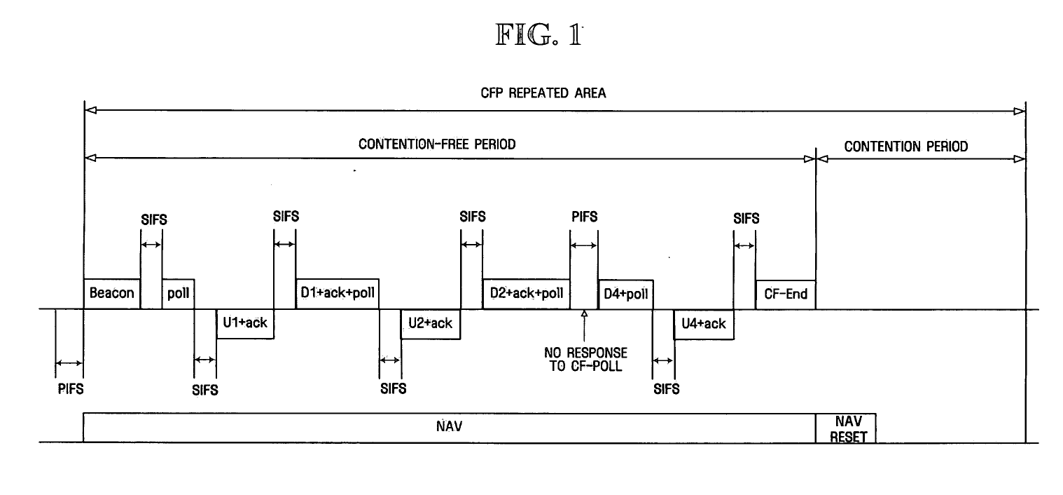

FIG. 2 illustrates backoff according to a general DCF;

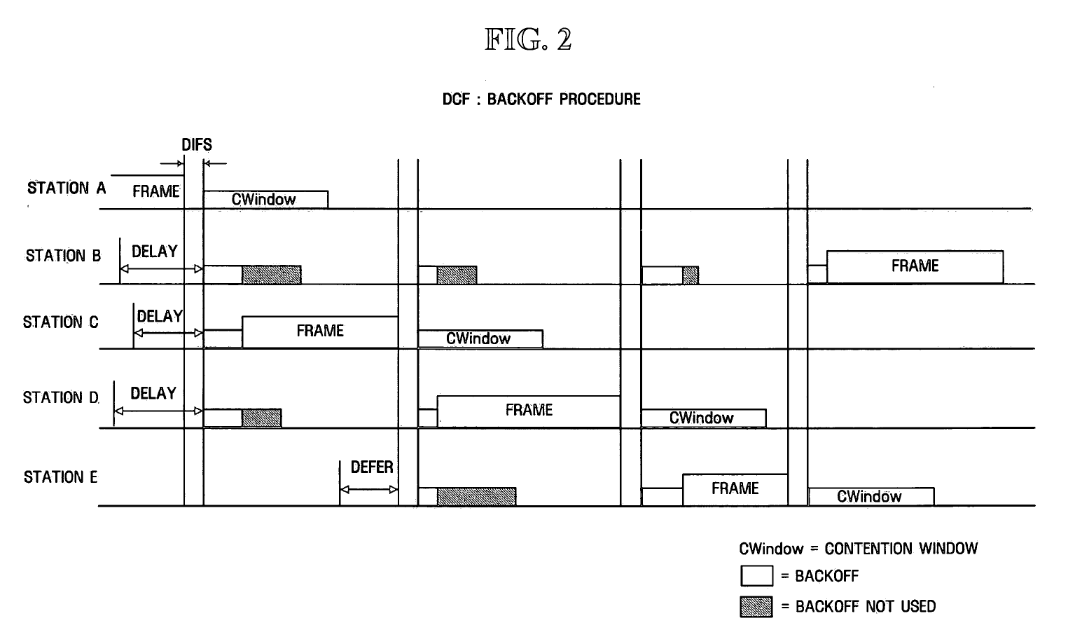

FIG. 3 illustrates the entire bandwidth of a concerned channel and rates of data transmission of each wireless network when a large number of wireless networks perform data transmission and reception through the same channel;

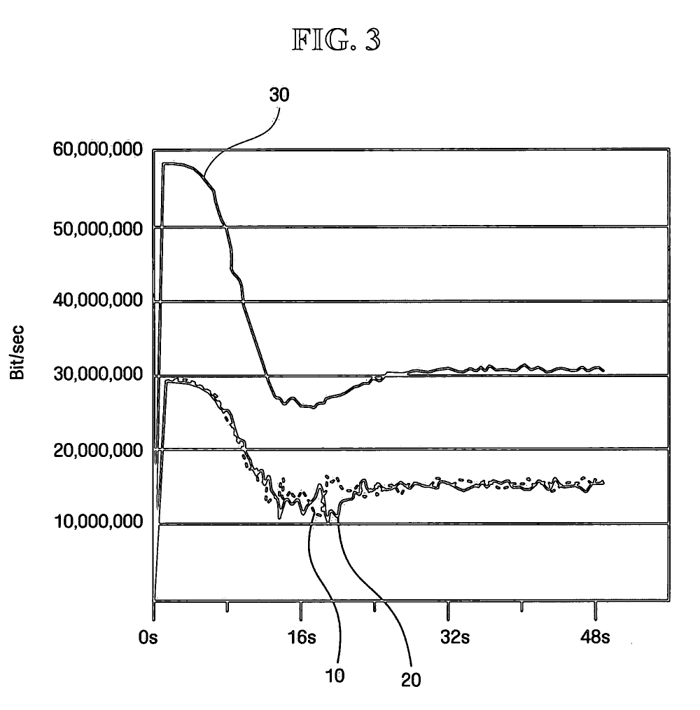

FIG. 4 illustrates a wireless network according to an application of the present invention;

FIG. 5 illustrates a wireless networking apparatus according to an exemplary embodiment of the present invention;

FIG. 6 illustrates switching of a channel used in data transmission and reception by an access point according to an exemplary embodiment of the present invention; and

FIG. 7 illustrates switching of a channel by a station transmitting and receiving data with an access point according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of the exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in detail with reference to the accompanying drawings.

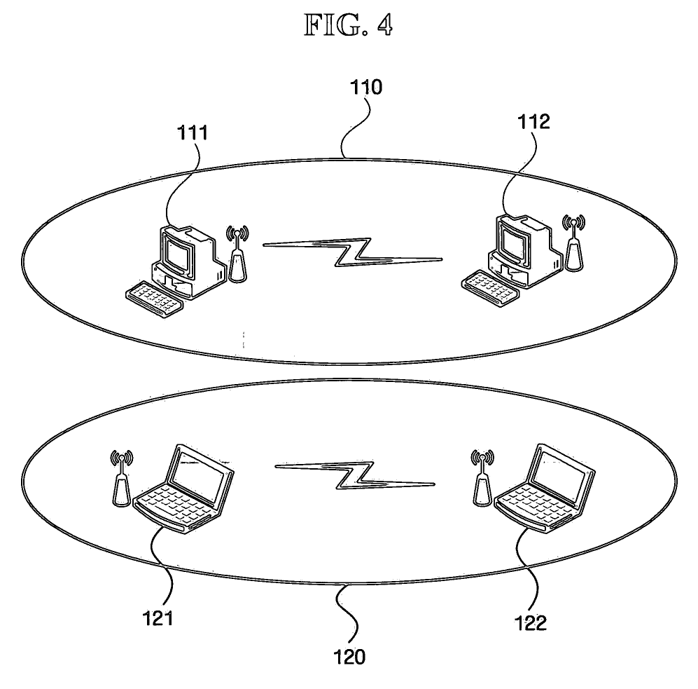

FIG. 4 illustrates a wireless network according to an application of the present invention.

A wireless network may generally comprise a plurality of wireless networks, e.g., first and second wireless networks 110 and 120 in FIG. 4, and each wireless network may comprise a plurality of stations, e.g., stations 111, 112, 121 and 122 in FIG. 4, that communicate with one another.

The exemplary embodiments of the present invention will be described for the case where the plurality of wireless networks consist of the first wireless network 110 which has an IEEE 802.11a-based BSS and the second wireless network 120 which has a non-IEEE 802.11a-based BSS, by way of example.

The present invention will also be described with respect to a case where the wireless network is a BSS, as an example, but the present invention is not limited thereto. The present invention can be applied to any wireless network operating in an IBSS mode.

The first wireless network 110 may comprise an access point 111 and a station 112 conducting data transmission and reception with the access point 111 through a predetermined channel.

The first wireless network 110 based on IEEE 802.11a employs carrier sense multiple access (CSMA) technology to prevent data collision with other wireless networks.

IEEE 802.11a enables a DFS mechanism to thereby reduce interface with other wireless networks and secure wider bandwidth.

In other words, a channel may be switched among wireless networks based on IEEE 802.11a, in order to secure the quality of service (QoS) of data transmitted and received through the DFS mechanism.

Since the second wireless network 120 has a BSS which is not based on IEEE 802.11a, the first wireless network 110 cannot recognize the second wireless network 120.

When data transmission and reception is performed between the access point 111 and the station 112 in the first wireless network 110, it may be difficult to secure the QoS of the data transmitted if the second wireless network 120 transmits and receives the data through the same channel as the first wireless network 110.

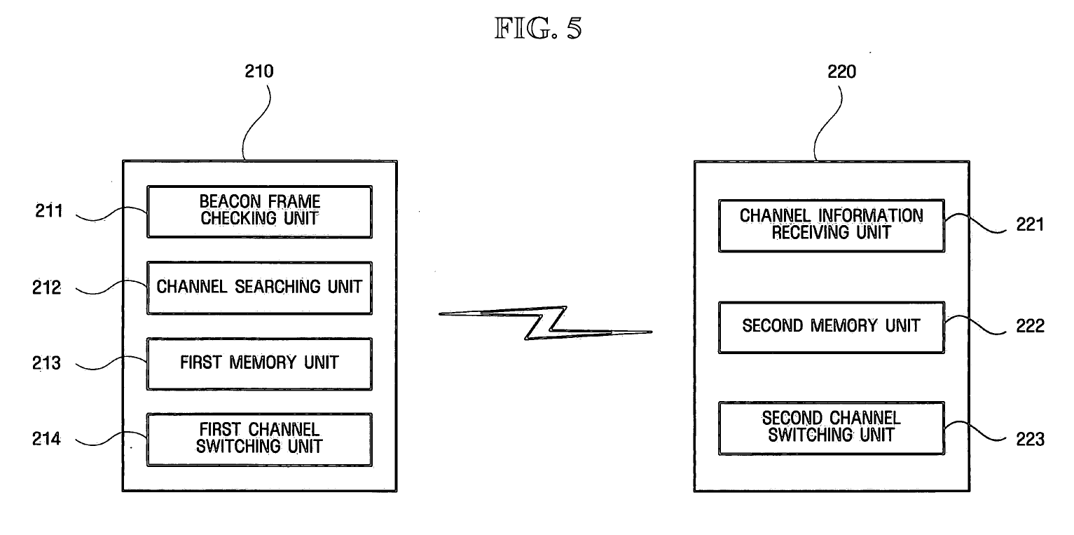

FIG. 5 illustrates a wireless networking apparatus according to an exemplary embodiment of the present invention.

As illustrated, the wireless networking apparatus according to an exemplary embodiment of the present invention comprises an access point 210 and a station 220 which performs data transmission and reception with the access point 210.

In this exemplary embodiment, the access point 210 and the station 220 correspond to the access point 111 and the station 112, respectively, of the first network illustrated in FIG. 4.

The access point 210 comprises a beacon frame checking unit 211 which determines whether a beacon frame to be transmitted to the station 220 has been transmitted, a channel searching unit 212 which searches for another channel as a result of the determination, a first memory unit 213 which stores channel information on the searched channel, and a first channel switching unit which switches the current channel to a concerned channel as a result of the search.

For reference, a beacon frame may comprise information on control of a frame, a duration of a frame, a destination address (DA), a source address (SA), a basic service set identification (BSSID), and sequence control.

The beacon frame checking unit 211 can determine whether a beacon frame has actually been transmitted through an interrupt caused when transmitting the beacon frame to the station 220.

If it is determined that the beacon frame has not been transmitted, the beacon frame transmitting unit 211 keeps a count of the number of failed transmission attempts.

If the number of failures exceeds a reference number, the channel searching unit 212 may search for an available channel to switch to.

In detail, when multimedia data is transmitted in the second wireless network 120, as described in FIG. 4, the access point 111 of the first network 110 will not have an opportunity to transmit a beacon frame through the same channel, thereby resulting in beacon transmission failure.

At this time, if the second wireless network 120 continuously transmits multimedia data, transmission of the beacon frame may recursively fail in the access point 111 of the first wireless network 110.

If transmission failures of the beacon frame are recursive, another channel is searched for since it is difficult to secure the QoS of the data to be transmitted and received through the concerned channel.

At this time, the channel searching unit 212 can search for a channel meeting any predetermined condition.

For example, the channel searching unit 212 may search for a channel that is the longest possible distance from the current channel or a channel having no adjacent channel, but the present invention is not limited thereto.

These channel searching conditions may vary according to the network environment.

If a channel meeting a search condition is found, the channel searching unit 212 stores channel information associated with the channel, including channel frequency, channel switching time, etc., in the first memory unit 213.

At this time, if channel information stored in advance exists in the first memory unit 213, it may be updated with channel information of the searched channel.

The first channel switching unit 214 transmits the updated channel information to a station existing in the same wireless network, thereby allowing data transmission and reception to be conducted through the channel specified in the updated channel information.

The station 220 comprises a channel information receiving unit 221 to receive channel information from the access point 210, a second memory unit 222 to store the received channel information therein, and a second channel switching unit 223 to switch the current channel to a channel corresponding to the received channel information, thereby enabling data transmission and reception with the access point 210.

The channel information receiving unit 221 may receive channel information including a channel frequency and a channel switching time associated with the channel searched by the channel searching unit 212.

At this time, if the received channel information is different from the channel information stored in advance in the second memory unit 222, the channel information receiving unit 221 may update the stored channel information based on the received channel information.

The second channel switching unit 223 switches the current channel to the channel specified in the channel information received by the channel information receiving unit 221 to thereby enable data transmission and reception with the access point 210.

In this embodiment, the first memory unit 213 and the second memory unit 222 may include plural devices in the form of a cache, a read only memory (ROM), a programmable read only memory (PROM), an erasable programmable read only memory (EPROM), an electrically erasable programmable read only memory (EEPROM), a flash, a static random access memory (SRAM) and a dynamic random access memory (DRAM), but the present invention is not limited thereto.

A channel switching method using the wireless networking apparatus described above according to an exemplary embodiment of the present invention will be described below.

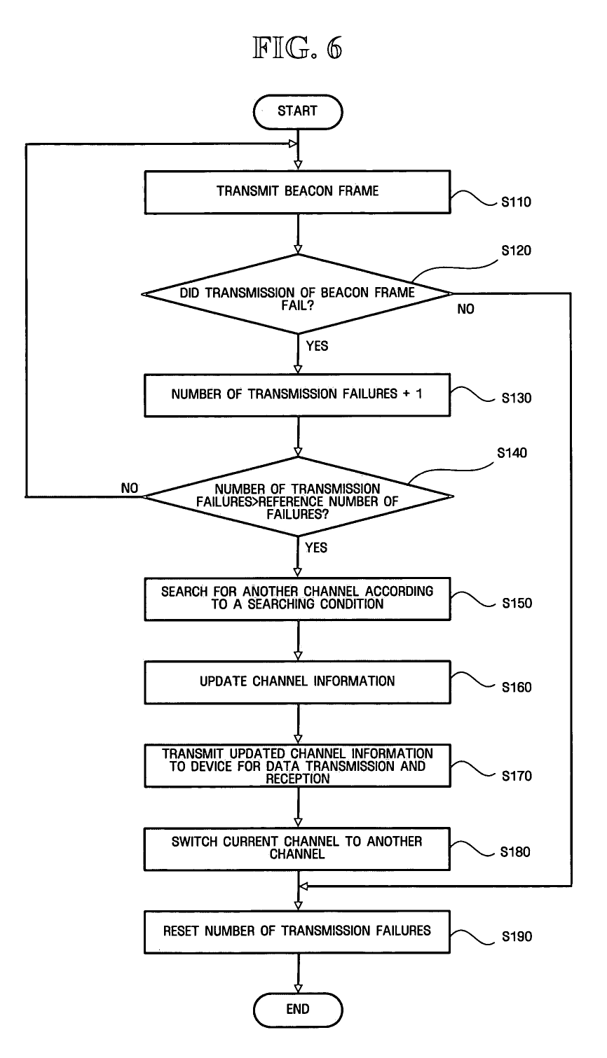

FIG. 6 illustrates a method of switching a channel used in data transmission and reception at an access point according to an exemplary embodiment of the present invention.

As illustrated, the beacon frame checking unit 211 first transmits a beacon frame through the current channel (S110), and determines whether transmission of the beacon frame has succeeded (S120).

A beacon frame transmission failure may be determined through an interrupt produced when the access point 210 transmits the beacon frame.

If it is determined that transmission of the beacon frame has failed, the beacon frame checking unit 211 adds 1 to the number of transmission failures of the beacon frame (S130), and it compares the number of transmission failures of the beacon frame with the reference number of failures (S140).

If it is determined as a result of the comparison that the number of transmission failures of the beacon frame exceeds the reference number of failures, the channel searching unit 212 searches for another channel according to a predetermined searching condition (S150).

At this time, the channel searching unit 212 creates a list of available channels, and searches this list for a channel meeting the predetermined search condition.

For example, the channel searching unit 212 may search for a channel that is the longest possible distance from the current channel or for a channel having no adjacent channel, but the present invention is not limited thereto.

If a channel meeting the search condition is found, the channel searching unit 212 updates the channel information stored in the first memory unit 213 with the channel information of the new channel (S160).

In addition, the first channel switching unit 214 transmits the updated channel information to the station 220 (S170), and the first channel switching unit 214 switches the access point 210 to the channel specified in the updated channel information (S180).

Thereafter, the number of transmission failures of the beacon frame is reset (S190), and data transmission and reception is performed via the new channel.

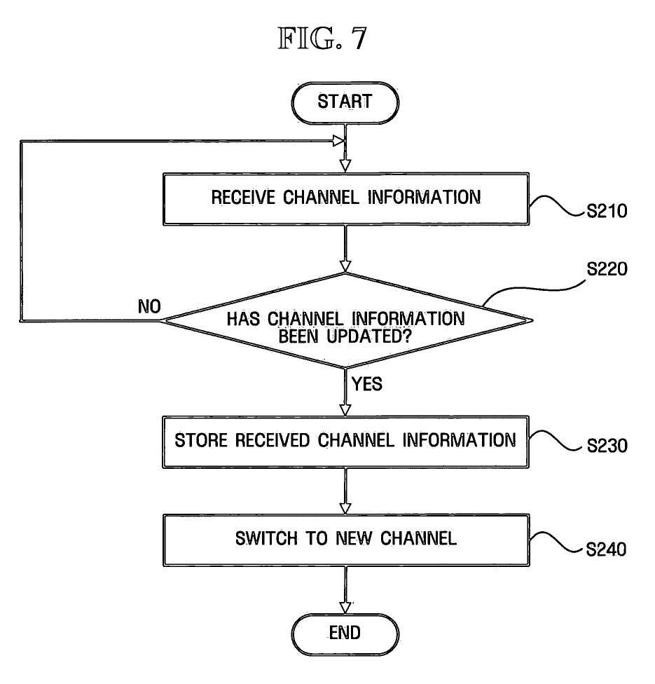

FIG. 7 illustrates a method of switching a channel of the station 220 performing data transmission and reception with the access point 210.

As illustrated, the channel information receiving unit 221 receives channel information from the access point 210 (S210).

The channel information may be received at regular predetermined intervals, or whenever the channel information is updated.

The channel information receiving unit 221 compares the received channel information with the channel information pre-stored in the second memory unit 222, and determines whether the received channel information has been updated (S220).

If it determined as a result of the comparison that the received channel information has been updated, the channel information receiving unit 221 updates the channel information stored in the second memory unit 222 to the received channel information (S230).

The channel switching unit 223 ascertains the channel frequency and the channel switching time included in the updated channel information, and switches the channel to the new channel (S240).

Thereafter, the station 220 performs data transmission and reception with the access point 210 through the new channel.

According to the wireless networking apparatus and the channel switching method according to the present invention (as described above), the state of a channel currently in use is determined and data transmission and reception is conducted by switching the current channel to another channel when the channel switching is required as a result of the determination, thereby avoiding data collision with other wireless networks and securing the QoS of the data.

It will be understood by those of ordinary skill in the art that various replacements, modifications and changes in form and details may be made therein without departing from the spirit and scope of the present invention as defined by the following claims. Therefore, it is to be appreciated that the above-described exemplary embodiments are for purposes of illustration only and are not to be construed as limiting the invention.

What is claimed is:

1. A wireless networking apparatus comprising:
a beacon frame checking unit which determines whether a beacon frame to be transmitted to a device has been transmitted;
a channel searching unit which searches for another channel according to a result of the determination by the beacon frame checking unit; and
a channel switching unit which switches a current channel to the other channel which is found as a result of the search by the channel searching unit.

2. The apparatus of claim 1, further comprising a memory unit, wherein the channel searching unit stores channel information associated with the other channel in the memory unit.

3. The apparatus of claim 2, wherein the beacon frame checking unit determines whether the transmission has been successful based on an interrupt produced when transmitting the beacon frame.

4. The apparatus of claim 3, wherein the channel searching unit searches for the other channel according to a predetermined search condition, if a number of transmission failures of the beacon frame exceeds a reference number of failures.

5. The apparatus of claim 3, wherein the channel searching unit updates channel information stored in the memory unit with the channel information associated with the other channel.

6. The apparatus of claim 2, wherein the channel searching unit transmits the channel information associated with the other channel to a station existing in a wireless network to which wireless networking apparatus belongs.

7. A wireless networking apparatus comprising:
a channel information receiving unit which receives channel information from a device;
a memory unit which stores the channel information received by the channel information receiving unit therein; and
a channel switching unit which switches a current channel to a channel specified in the channel information stored in the memory unit.

8. The apparatus of claim 7, wherein the channel information is received if a number of transmission failures of the beacon frame exceeds a reference number of failures.

9. The apparatus of claim 8, wherein the channel specified in the channel information is a current channel of the device.

10. A channel switching method of a wireless networking apparatus, the method comprising:
determining whether a beacon frame to be transmitted to a device has been transmitted;
searching for another channel as a result of the determining; and
switching a current channel of the wireless networking apparatus to the other channel which is found as a result of the searching.

11. The method of claim 10, wherein transmission of the beacon frame is determined based on an interrupt of beacon transmission produced when transmitting the beacon frame.

12. The method of claim 11, wherein the other channel is searched according to a predetermined search condition if a number of transmission failures of the beacon frame exceeds a reference number of failures.

13. The method of claim 12, further comprising storing channel information associated with the other channel which is found as a result of the searching.

14. The method of claim 12, further comprising transmitting the channel information associated with the other channel to a station existing in a wireless network to which wireless networking apparatus belongs.

15. A channel switching method of a wireless networking apparatus, the comprising:
receiving channel information from a device;
storing the channel information which is received; and
switching a current channel of the wireless networking apparatus to a channel specified in the channel information.

16. The method of claim 15, wherein the channel information is received if a number of transmission failures of the beacon frame exceeds a reference number of failures.

17. The method of claim 16, wherein the channel specified in the channel information is a current channel of the device.
